(19) United States
(12) Patent Application Publication
(10) Pub. No.: US 2022/0106489 A1
(43) Pub. Date: Apr. 7, 2022

(54) TWO-LIQUID-TYPE EPOXY-BASED COATING COMPOSITION AND AEROSOL-TYPE EPOXY-BASED COATING COMPOSITION FOR INITIAL FIRE EXTINCTION USING CAPSULE-TYPE FIRE EXTINGUISHING AGENT

(71) Applicant: SOO CO., LTD., Busan (KR)

(72) Inventor: Deuk Kyu HWANG, Busan (KR)

(21) Appl. No.: 17/554,320

(22) Filed: Dec. 17, 2021

Related U.S. Application Data
(63) Continuation of application No. PCT/KR2020/004285, filed on Mar. 30, 2020.

(30) Foreign Application Priority Data
Jun. 26, 2019 (KR) 10-2019-0076257

(51) Int. Cl. C09D 5/18; C09D 7/40; C09D 7/63; C09D 163/00; A62D 1/00

(52) U.S. Cl. CPC C09D 5/18; C09D 7/70; A62D 1/0021; C09D 163/00; C09D 7/63

(57) ABSTRACT

Proposed is a two-component-type epoxy-based coating composition and aerosol-type epoxy-based coating composition for initial fire extinction, using a capsule-type fire extinguishing agent. The two-liquid-type epoxy-based coating composition using a capsule-type fire extinguishing agent for initial fire extinction includes a main agent and a curing agent. The main agent includes 10 to 50 parts by weight of an epoxy binder, 10 to 60 parts by weight of a solvent, 10 to 50 parts by weight of a capsule-type fire extinguishing agent, 5 to 40 parts by weight of a pigment, and 0.01 to 10 parts by weight of an additive. The curing agent includes 30 to 80 parts by weight of a curing agent binder, 10 to 60 parts by weight of a solvent, and 0.01 to 10 parts by weight of an additive. The main agent and the curing agent are mixed in a volume ratio that falls within a range of 1:1 to 10:1.

### REFERENCE TO RELATED APPLICATIONS

This is a continuation of pending International Patent Application PCT/KR2020/004285 filed on Mar. 30, 2020, which designates the United States and claims priority of Korean Patent Application No. 10-2019-0076257 filed on Jun. 26, 2019, the entire contents of which are incorporated herein by reference.

### FIELD OF THE INVENTION

The present invention relates to a two-component-type epoxy-based coating composition using capsule-type fire extinguishing agent for initial fire suppression and to an aerosol-type epoxy-based coating composition.

### BACKGROUND OF THE INVENTION

Conventional fire suppression was primarily focused on directly extinguishing a fire using a fire extinguisher. However, with the development of technology, various types of fire extinguishing systems, including a gas fire extinguishing system, a powder fire extinguishing system, and a water-based fire extinguishing system, have been developed and are being widely used. Briefly describing the mechanisms of fire extinguishing systems, the gas fire extinguishing system extinguishes fire by using a physical fire extinguishing mechanism of reducing the oxygen concentration at the fire site, the powder fire extinguishing system extinguishes fire by using a physicochemical action of bringing powder sprayed due to the action of compressed air into contact with the flame, and the water-based fire extinguishing system extinguishes fire by using three actions: cooling of water mist, suffocation, and blocking of thermal radiation.

In the case of fires occurring in collective facilities such as apartment complexes, underpasses, and subway trains, it is difficult to directly extinguish the fire by using these fire extinguishing systems due to the generation of toxic substances and gases. In order to prevent the fire from spreading in such facilities, flame retardant materials or paints are used to passively block the spread of fire.

In relation to this passive fire blocking, Korean Patent Application Publication No. 10-2011-0051395 discloses a foamed fire resistant paint. Specifically, it is described that when oil-based and water-based binders, a flame retardant, a non-flammable inorganic compound, a reinforcing agent, a foaming agent, and expanded graphite are added to a paint composition, it is possible to form a foamed fire-resistant paint layer that has good thermal insulation properties and is rarely chipped, worn, or stripped off by wind. However, there is a limit in that the paint layer has only a function of delaying the spread of fire but does not have an early fire suppression function for initial fire. Accordingly, a fire extinguishing system with an early fire suppression function and a fire-fighting function capable of preventing fire.

In addition, Korean Patent Application Publication No. 10-2018-0043570 discloses a paint composition having a fire-fighting function and a fire-fighting sheet using the same paint composition. According to the document, the paint composition contains polyurethane resin, MMA, and a fire extinguishing agent. Therefore, the paint composition and the sheet have a problem of poor adhesiveness to various materials. This results in a problem that it is necessary to start with epoxy undercoating prior to application of the polyurethane-type paint. In addition, when a fire extinguishing agent is directly added, a problem occurs in the long-term storage of the paint composition.

### SUMMARY OF THE INVENTION

The present invention has been made to solve the problems occurring in the related art. A technical objective of the present invention is to provide a two-component-type epoxy-based coating composition for early fire suppression, the coating composition having high adhesion to the surface of a floor, having no problem with long-term storage, and being capable of actively suppressing an initial fire. Specifically, unlike a passive fire suppression technique of applying a fire-resisting material, a fire-resisting member, or a fire-resisting paint, which can resist high temperatures without burning, to the surface of an object, since the coating composition of the present invention contains a capsule-type fire extinguishing agent containing extinguishing substances, the extinguishing agent actively suppresses an initial fire when the initial fire occurs.

Another technical objective of the present invention is to provide an aerosol-type coating composition using a capsule-type fire extinguishing agent for suppressing an initial fire, the coating composition being capable of easily applied on an inner surface of a vehicle bonnet, an inner surface of an electric switchboard, and the like.

To accomplish one technical objective, the present invention provides a two-component-type epoxy-based coating composition including a main agent and a curing agent, in which the main agent includes 10 to 50 parts by weight of an epoxy binder, 10 to 60 parts by weight of a solvent, 10 to 50 parts by weight of a capsule-type fire extinguishing agent, 5 to 40 parts by weight of a pigment, 0.01 to 10 parts by weight of an additive, and the curing agent includes 30 to 80 parts by weight of a curing agent binder, 10 to 60 parts by weight of a solvent, and 0.01 to 10 parts by weight of an additive. In the composition, the main agent and the curing agent are mixed in a volume ratio in a range of from 1:1 to 10:1.

Preferably, the capsule-type extinguishing agent has a core-shell structure in which the core includes a fluorinated ketone-based extinguishing agent and the shell is formed of a cross-linked polymer.

Preferably, the epoxy binder may include at least one selected from the group consisting of bisphenol A, bisphenol F, brominated, novolac, and polymer-type epoxy resins.

Preferably, the curing agent binder may include at least one selected from the group consisting of amines, polyamines, modified amines, and tertiary amines.

To accomplish another technical objective, the present invention provides an aerosol-type coating composition using a capsule-type extinguishing agent for initial fire suppression, the composition including 100 parts by weight of the two-component epoxy-based coating composition using the capsule-type extinguishing agent for initial fire suppression, and 50 to 200 parts by weight of a liquefied gas propellant that is liquefied petroleum gas (LPG) or dimethyl ether (DME).

The two-component epoxy-based coating composition for initial fire suppression, according to the present invention, uses the capsule-type fire extinguishing agent. The capsule-type fire extinguishing agent is embedded in a coating film, and the capsule reacts to heat of 90° C. to 230° C. at an early stage of fire so that the extinguishing agent in the capsule scatters, thereby suppressing the initial fire. In addition, since the extinguishing agent is contained in the capsule, the long-term storage of the extinguishing agent can be improved.

In addition, since the coating composition according to the present invention contains an epoxy binder, the coating composition has good adhesion to various materials. Therefore, the coating composition can be applied to the surface of objects made of various materials.

In addition, according to the present invention, it is possible to provide an aerosol-type epoxy-based coating composition including a liquefied gas propellant. Therefore, the coating composition can be applied to the surfaces in complex and places with a high fire risk such as the inside of a car bonnet or the inside of an electric switchboard. Therefore, the coating composition can be conveniently used.

### BRIEF DESCRIPTION OF THE DRAWINGS

FIG. 1 is a photograph showing the results of an initial fire suppression test according to an embodiment of the present invention.

### DETAILED DESCRIPTION OF THE INVENTION

Hereinafter, the present invention will be described in detail.

One aspect of the present invention relates to a two-component-type epoxy-based coating composition for initial fire suppression, the composition using a capsule-type extinguishing agent. The composition includes a main agent and a curing agent. The main agent includes 10 to 50 parts by weight of an epoxy binder, 10 to 60 parts by weight of a solvent, 10 to 50 parts by weight of a capsule-type fire extinguishing agent, 5 to 40 parts by weight of a pigment, and 0.01 to 10 parts by weight of an additive. The curing agent includes 30 to 80 parts by weight of a curing agent binder, 10 to 60 parts by weight of a solvent, 0.01 to 10 parts by weight of an additive. The main agent and the curing agent are mixed in a volume ratio in the range from 1:1 to 10:1.

In the present invention, the epoxy binder refers to an epoxy resin used as a binder, and the epoxy resin is not particularly limited as long as it has at least one epoxy group in the molecule thereof. The epoxy resin may be bisphenol A, bisphenol F, brominated, novolac, and polymer-type epoxy resins. Specifically, one resin or a mixture of two or more resins selected from the following compounds may be used: bisphenol A epoxy resins (diglycidyl ether of bisphenol A (DGEBA)); bisphenol F epoxy resins (diglycidyl ether of bisphenol F (DGEBF)); novolac epoxy resin such as phenol novolac epoxy and/or cresol novolac epoxy; halogenated epoxy such as brominated epoxy; and polymer-type epoxy resins such as cycloaliphatic epoxy, rubber modified epoxy, aliphatic polyglycidyl epoxy, glycidylamine epoxy, polyglycol epoxy, or cardanol-based epoxy.

In general, the smaller the equivalent weight of the epoxy resin, the shorter the chain length between epoxy rings, and the higher the crosslinking density. On the other hand, the larger the equivalent weight of the epoxy resin, the lower the crosslinking density. Accordingly, when an epoxy resin having a small equivalent weight is used, the crosslinking density is increased to improve abrasion resistance and heat resistance. However, when the crosslinking density is excessively high, the coating film is apt to be brittle or is easily cracked. In the present invention, the equivalent weight of the epoxy resin is not particularly limited. The equivalent weight of the epoxy resin is determined in consideration of the mechanical properties, heat resistance and/or surface cracks.

The epoxy resin may be included in an amount of 10 to 50 parts by weight in the main agent of the coating composition of the present invention. When the content of the epoxy resin in the coating composition is excessively low, for example, less than 10 parts by weight, it may be difficult for the coating composition to exhibit sufficiently good adhesion and mechanical properties expected as the effects of the use of the epoxy resin. When the content of the epoxy resin is excessively high, for example, greater than 50 parts by weight, the contents of other components are relatively lowered, and thus the viscosity and flowability are lowered. That is, coatability, smoothness, etc. may become deteriorated.

In addition, in the present invention, the pigment is not particularly limited. That is, any kind of pigment among organic, inorganic, and colored pigments and extender pigments can be used. Preferably, the pigment may be contained in an amount of 5 to 40 parts by weight. The colored pigments makes a coating film formed of the coating composition exhibit respective colors, and the extender pigments facilitates the formation of a coating film. Since each pigment has a different absorption, the properties of each pigment need to be checked before the pigment can be used.

In addition, in the present invention, the capsule-type fire extinguishing agent includes a shell formed of cross-linked gelatin and a core formed of a fluorinated ketone-based fire extinguishing agent. The capsule-type fire extinguishing agent is based on the principle that the gelatin shell thereof is destroyed due to heat at 90° C. to 230° C. when catching a fire. At this time, the nano-sized fire extinguishing agent in the gelatin shell is exposed. The capsule-type fire extinguishing agent has a particle size of 10 to 400 μm. Since the capsule-type fire extinguishing agent has such a micro-order size, it can be effectively applied to a paint to form a film having a smooth surface and being capable of suppressing an initial fire. Regarding this, the capsule-type fire extinguishing agent is preferably included in an amount of 10 to 50 parts by weight. This is because the fire extinguishing effect is not sufficient when the amount is less than 10 parts by weight whereas the storage stability is not good, the viscosity of the coating composition is increased, and gelation of the coating composition occurs in severe cases when the amount exceeds 50 parts by weight.

In addition, in the present invention, the solvent is not particularly limited, but it is preferable to include at least one selected from among aliphatic hydrocarbons, aromatic hydrocarbons, ketones, esters, and ethers. In relation to this, the solvent is preferably included in an amount of 10 to 60 parts by weight. When the content of the solvent is less than 10 parts by weight, it is difficult to form a uniform coating film because the viscosity of the paint is high. On the other hand, when the content of the solvent exceeds 60 parts by weight, the solid volume ratio (SVR) of the coating composition is too low to form a coating film.

In addition, in the present invention, the additives of the main agent are determined depending on the characteristics of the pigment and the use of the coating composition. The additives may include a dispersant, an antifoaming agent, a leveling agent, an adhesion enhancer, and a rust preventive agent. In this regard, the additives are preferably collectively included in an amount of 0.01 to 10 parts by weight. This is because, when the content of the additive is less than 0.01 parts by weight, the effect of the dispersant cannot be properly exhibited, and when the content of the additive exceeds 10 parts by weight, problems such as pinholes, color separation, and poor drying may occur.

In addition, in the present invention, as the curing agent binder, at least one selected from amine-type curing agent binders, polyamine-type curing agent binders, modified amine-type curing agent binders, and tertiary amine-type curing agent binders. Preferably, the curing agent binder is included in an amount of 10 to 60 parts by weight. This is because, when the epoxy binder of the main agent is less than 10 parts by weight, sufficient curing cannot be achieved and thus the chemical and mechanical properties of the coating film are deteriorated. On the other hand, when the content of the curing agent binder exceeds 60 parts by weight, the coating film is quickly cured, resulting in the following problems: deterioration in the physical properties of the coating film; deterioration in interlayer adhesion because the amine cannot sufficiently combine with the epoxy within the short curing time; and deterioration in the rust prevention effect.

In addition, in the present invention, preferably, the content of the solvent in the curing agent ranges from 10 to 60 parts by weight, and the solvent in the curating agent may be the same solvent included in the main agent. When the content of the solvent is less than 10 parts by weight, it is difficult to form a uniform coating film because the viscosity of the coating composition is too high. On the other hand, when the content of the solvent exceeds 60 parts by weight, the solid volume ratio (SVR) of the coating composition is too low to form a coating film.

In addition, in the present invention, the additives in the curing agent are determined depending on the type of the curing agent binder and the use of the coating composition. In addition, a reaction accelerator can be further included depending on the seasonal temperature.

In addition, in the present invention, the volume ratio of the main agent and the curing agent is preferably in a range of 1:1 to 10:1. According to the volume ratio, the drying speed, mechanical properties, chemical properties of the resulting coating film may greatly vary. Therefore, it is important to meet the predetermined volume ratio.

In another aspect, the present invention relates to an aerosol-type epoxy-based coating composition for initial fire suppression, in which the above-described capsule-type fire extinguishing agent is included. Specifically, the aerosol-type epoxy-based coating composition includes: 100 parts by weight of the two-component epoxy-based coating composition; and 50 to 200 parts by weight of a liquefied gas propellant that is liquefied petroleum gas (LPG) or dimethyl ether (DME), with respect to 100 parts by weight of the aerosol-type epoxy-based coating composition. In relation to this, when the amount of the liquefied gas propellant is less than 50 parts by weight, the amount of injected gas is too small to properly eject the coating composition. In this case, the thickness of the resulting coating film is smaller than expected so that the coating film cannot exhibit satisfiable mechanical and chemical properties. On the other, when the amount of the liquefied gas propellant exceeds 200 parts by weight, there is a problem in that it is difficult to form a coating film to a desired thickness because the coating composition is excessively sprayed.

Hereinafter, the present invention will be described in more detail with reference to examples, but the present invention is not limited the examples.

### <EXAMPLE 1>EPOXY COATING COMPOSITION CONTAINING A CAPSULE-TYPE FIRE EXTINGUISHING AGENT

A main agent was prepared by stirring a mixture of: 40 parts by weight of a bisphenol A-type epoxy binder; as solvents, 20 parts by weight of xylene, 5 parts by weight of propylene glycol methyl ether (PM), 5 parts by weight of solvent naphtha, 5 parts by weight of methyl isobutyl ketone (MIBK, 4-Methyl-2-pentanone), and 5 parts by weight of ethylbenzene; 20 parts by weight of a capsule-type fire extinguishing agent; 10 parts by weight of titanium dioxide (TiO2), which is a white pigment; 15 parts by weight of talc; 10 parts by weight of mica; and as additives, 1.5 parts by weight of a dispersant and 1.5 parts by weight of a wetting agent.

A curing agent was prepared by stirring a mixture of 70 parts by weight of an amine-type curing agent binder, 20 parts by weight of xylene as a solvent, 10 parts by weight of n-butanol (N-BuOH, n-Butyl alcohol), 10 parts by weight of ethylbenzene, and additives. The additives include 1 part by weight of an antifoaming agent, 0.5 parts by weight of a leveling agent, and 0.5 parts by weight of a wetting agent.

### <EXAMPLE 2>EPOXY COATING COMPOSITION CONTAINING A COMMON FIRE EXTINGUISHING AGENT

A main agent was prepared by stirring a mixture of: 40 parts by weight of a bisphenol A-type epoxy binder; as solvents, 20 parts by weight of xylene, 5 parts by weight of propylene glycol methyl ether (PM), 5 parts by weight of solvent naphtha, 5 parts by weight of methyl isobutyl ketone (MIBK, 4-Methyl-2-pentanone), and 5 parts by weight of ethylbenzene; as powder-type fire extinguishing agents, 10 parts by weight of sodium hydrogen carbonate and 10 parts by weight of potassium hydrogen carbonate; 10 parts by weight of titanium dioxide (TiO₂), which is a white pigment; 15 parts by weight of talc; 10 parts by weight of mica; and as additives, 1.5 parts by weight of a dispersant and 1.5 parts by weight of a wetting agent.

A curing agent was prepared by stirring a mixture of 70 parts by weight of an amine-type curing agent binder, 20 parts by weight of xylene as a solvent, 10 parts by weight of n-butanol (N-BuOH, n-Butyl alcohol), 10 parts by weight of ethylbenzene, and additives. The additives include 1 part by weight of an antifoaming agent, 0.5 parts by weight of a leveling agent, and 0.5 parts by weight of a wetting agent.

### <EXAMPLE 1>COMMON EPOXY COATING COMPOSITION

A main agent was prepared by stirring a mixture of: 40 parts by weight of a bisphenol A-type epoxy binder; as solvents, 20 parts by weight of xylene, 5 parts by weight of propylene glycol methyl ether (PM), 5 parts by weight of solvent naphtha, 5 parts by weight of methyl isobutyl ketone (MIBK, 4-Methyl-2-pentanone), and 5 parts by weight of ethylbenzene; 10 parts by weight of titanium dioxide (TiO₂), which is a white pigment; 25 parts by weight of talc; 20 parts by weight of mica; and as additives, 1.5 parts by weight of a dispersant and 1.5 parts by weight of a wetting agent.

### <EXPERIMENTAL EXAMPLE 1>MEASUREMENT OF BASIC PHYSICAL PROPERTIES OF COATING COMPOSITION

Coating compositions were prepared by mixing the main agent and the curing agent prepared in Examples 1 and 2 and Comparative Example 1 in a volume ratio of 4:1. The viscosity, specific gravity, flowability, and drying time of the coating compositions were measured. In the experiment, the drying time was measured at a temperature of 23° C. and a humidity of 43% for a 200-μm wet film.

TABLE 1

| Initial | | | | | | |
|---|---|---|---|---|---|---|
| physical | Viscosity | Specific | Flowability | | | |
| properties | (KU) | gravity | (μm) | SVR(%) | Drying (minutes) | |
| Example 1 | 81 | 1.31 | 100 | 51 | Dry to touch | 30 |
| | | | | | Solidification | 400 |
| Example 2 | 95 | 1.33 | 100 | 50 | Dry to touch | 45 |
| | | | | | Solidification | 450 |
| Comparative | 78 | 1.35 | 100 | 52 | Dry to touch | 30 |
| Example 1 | | | | | Solidification | 390 |

The measurement results of the physical properties of each of coating films formed using the coating composition of Example 1 in which the capsule-type extinguishing agent was used, formed using the coating composition of Example 2 in which the powder-type extinguishing agent was used, and formed using the conventional epoxy paint of Comparative Example 1, showed that the specific gravity, flowability, and SVR are not significantly numerically different among the tested coating compositions. However, when the initial viscosity and dryness are compared among the compositions, the compositions of Example 1 of the present invention and Comparative Example 1 did not show a significant difference in physical properties. On the other hand, the composition of Example 2 in which the powder-type extinguishing agent was used exhibited a higher initial viscosity than the other compositions (Example 1 and Comparative Example 1), and a difference of about 15 minutes in dryness (measured by the dry-to-contact method) and a difference of about 60 minutes in solidification drying, compared to the other compositions.

### <EXPERIMENTAL EXAMPLE 2>STORAGE STABILITY TEST

1,000 g of each of the coating compositions as in Experimental Example 1 were put in respective sealed PE containers, initially put into an oven at 60° C., then refrigerated at low temperature (−10° C. to 0° C.), and then maintained at room temperature. At intervals of 1 day and at intervals of 7 to 8 days, changes in the viscosity and gelation of the coating compositions were observed initially at intervals of 1 day and then at intervals of 7 to 8 days for a total duration of 30 days. The results are shown in Table 2.

TABLE 2

| | | | | | After | After | |
|---|---|---|---|---|---|---|---|
| | | | After | After | 15 days | 22 days | After |
| Storage | | | 1 day of | 7 days of | of | of | 30 days |
| stability | Temperature | Test | storage | storage | storage | storage | of storage |
| Example 1 | 60° C. | Viscosity | 80KU | 86KU | 97KU | 101KU | 103KU |
| | | Gel | Normal | Normal | Normal | Normal | Normal |
| | Room | Viscosity | 81KU | 82KU | 92KU | 95KU | 100KU |
| | temperature | Gel | Normal | Normal | Normal | Normal | Normal |
| Example 2 | 60° C. | Viscosity | 97KU | 112KU | 134KU | 140KU | NA |
| | | Gel | Normal | Normal | Soft gel | Soft gel | Gel |
| | Room | Viscosity | 95KU | 104KU | 115KU | 127KU | 136KU |
| | temperature | Gel | Normal | Normal | Soft gel | Soft gel | Gel |
| Comparative | 60° C. | Viscosity | 75KU | 80KU | 85KU | 90KU | 96KU |
| Example 1 | | Gel | Normal | Normal | Normal | Normal | Normal |
| | Room | Viscosity | 75KU | 80KU | 83KU | 88KU | 92KU |
| | temperature | Gel | Normal | Normal | Normal | Normal | Normal |

The composition of Example 1 of the present invention using a capsule-type extinguishing agent and the composition of Comparative Example 1, which is a common epoxy paint, shows that they could be used without problems after long-term storage in conditions of room temperature and 60° C. However, in the case of Example 2 containing a powder extinguishing agent, the viscosity was increased by about 10 KU at intervals of 1 week, and the soft gel phenomenon of the coating composition started to occur after 2 weeks of storage, and the coating composition was completely gelled after 30 days of storage so that the coating composition cannot be used to form a coating film.

### <EXPERIMENTAL EXAMPLE 3>FIRE SUPPRESSION TEST

100 g of each of the coating compositions prepared in Examples 1 and 2, respectively, was diluted 20% by volume with an epoxy thinner (please tell us the name of the product). Each of the diluted coating compositions was applied to form a 200-μm wet film on a 150 mm×150 mm 2 T steel sheet, and dried at room temperature for 1 week to prepare test samples.

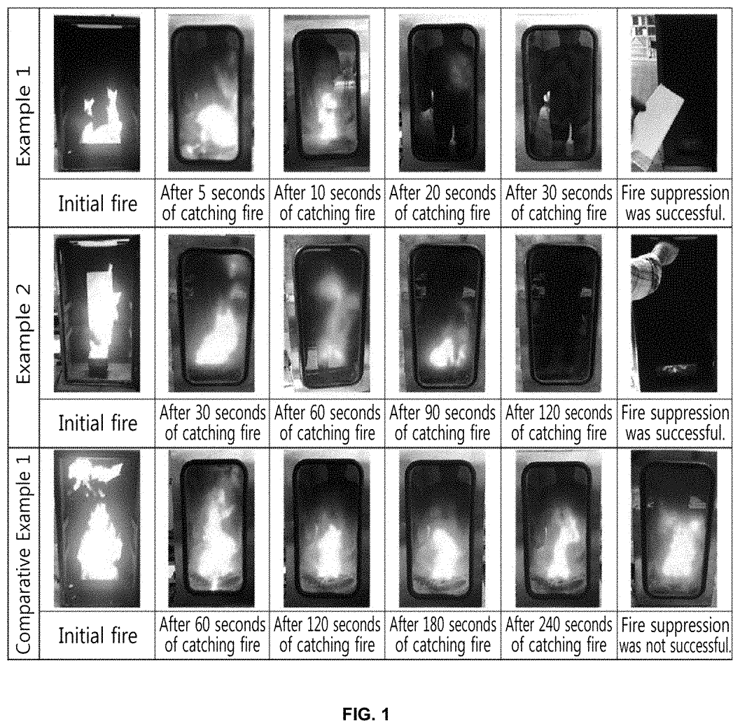

The test sample was placed in an openable iron test box with a volume of 30 L. In the test box, a fire extinguishing simulation model that was 80 mm in length, 80 mm in width, and 50 mm in height (material: iron, thickness: 3mm) and which was charged with normal heptane (n-heptane) up to a height of 30 mm was also placed together with the test sample. Next, the n-heptane was ignited and pre-burned for 30 seconds. Next, the door was closed, and the extinguishing time was measured a total of 5 times. The obtained results are presented in Table 3 and FIG. 1.

TABLE 3

| Fire extinguishing ability | Time (seconds) |
|---|---|
| Example 1 | 20 to 90 |
| Example 2 | 110 to 165 |
| Comparative Example 1 | Fire is not extinguished. |

As a result of the measurement, Comparative Example 1, which is a general epoxy paint, did not show the extinguishing effect, Example 2 using a powder-type extinguishing agent took 110 to 165 seconds to extinguish the fire, and Example 1 using a capsule-type extinguishing agent took 20 to 90 seconds to extinguish the fire. That is, the fire extinguishing performance of Example 1 was better than that of Example 2.

Since the specific parts of the present invention have been described in detail above, various modifications and variations will be possible without departing from the essential characteristics of the present invention for those who are ordinarily skilled in the art. The embodiments disclosed in the present disclosure are not intended to limit the scope of the present invention and the technical spirit of the present invention should not be construed as being limited to the embodiments. The protection scope of the present disclosure should be construed as defined in the following claims, and it is apparent that all technical ideas equivalent thereto fall within the scope of the present invention.

1. A two-component-type epoxy-based coating composition for initial fire suppression, the composition using a capsule-type extinguishing agent, the composition comprising: a main agent containing 10 to 50 parts by weight of an epoxy binder, 10 to 60 parts by weight of a solvent, 10 to 50 parts by weight of a capsule-type fire extinguishing agent, 5 to 40 parts by weight of a pigment, and 0.01 to 10 parts by weight of an additive; and a curing agent containing 30 to 80 parts by weight of a curing agent binder, 10 to 60 parts by weight of a solvent, 0.01 to 10 parts by weight of an additive, wherein the main agent and the curing agent are mixed in a volume ratio in the range from 1:1 to 10:1.

2. The two-component-type epoxy-based composition according to claim 1, wherein the capsule-type fire extinguishing agent has a core-shell structure in which the core comprises a fluorinated ketone-based extinguishing agent, and the shell is formed of a cross-linked polymer.

3. The two-component-type epoxy-based composition apparatus according to claim 1, wherein the epoxy binder comprises at least one selected from the group consisting of bisphenol A, bisphenol F, brominated, novolac, and polymer-type epoxy resins.

4. The two-component-type epoxy-based composition apparatus according to claim 1, wherein the curing agent binder comprises at least one selected from the group consisting of amines, polyamines, modified amines, and tertiary amines.

5. An aerosol-type epoxy-based paint composition using a capsule-type fire extinguishing agent for initial fire suppression, the aerosol-type epoxy-based paint composition comprising: 100 parts by weight of the composition according to claim 1; and 50 to 200 parts by weight of a liquefied gas propellant that is liquefied petroleum gas (LPG) or dimethyl ether (DME).
